(19) United States
(12) Patent Application Publication
(10) Pub. No.: US 2020/0151747 A1
(43) Pub. Date: May 14, 2020

(54) SEGMENTING USERS AND ASSOCIATED EVENTS TO PROVIDE ACTIONABLE INSIGHTS IN AN ECOMMERCE SYSTEM

(71) Applicant: Zendesk, Inc., San Francisco, CA (US)

(72) Inventors: Cheng Ying Tang, San Francisco, CA (US); Mate T. Rauscher, Burlingame, CA (US); Jordan S. Alviso, San Bruno, CA (US); Darioush X. Aghai-Yazdi, San Carlos, CA (US); Ngoc-Trung Nguyen, San Francisco, CA (US)

(73) Assignee: Zendesk, Inc., San Francisco, CA (US)

(21) Appl. No.: 16/370,547

(22) Filed: Mar. 29, 2019

Related U.S. Application Data
(63) Continuation-in-part of application No. 16/183,756, filed on Nov. 8, 2018.
(60) Provisional application No. 62/826,545, filed on Mar. 29, 2019.

(51) Int. Cl. G06Q 30/02; G06F 16/335; G06F 16/33

(52) U.S. Cl. CPC G06Q 30/0204; G06F 16/3341; G06F 16/335

(57) ABSTRACT

The disclosed embodiments relate to a system that segments users and associated events for an ecommerce system to facilitate actionable insights. During operation, the system receives a query to segment users of the ecommerce system and/or events associated with user actions, wherein the query comprises a Boolean expression with a list of filters that are applied attributes of the users and/or events to form filter groups, and wherein the filter groups are joined by logical operators. Next, the system performs a search based on the query to produce a result set comprising a list of users and/or events that satisfy the query. Finally, the system displays the result set to a customer-support agent for the ecommerce system to facilitate actionable insights.

### RELATED APPLICATION

This application is a continuation-in-part of, and hereby claims priority under 35 U.S.C. § 120 to, pending U.S. patent application Ser. No. 16/183,756, entitled “System and Method for Classifying Events to Facilitate Storage and Retrieval in an Event-Driven Computing System,” by inventors Cheng Ying Tang, et al., filed on 8 Nov. 2018 (Attorney Docket No. ZEN18-1005). This application also claims the benefit under 35 U.S.C. § 119 of U.S. Provisional Application No. 62/826,545, entitled “Events” by inventor Cheng Ying Tang, filed on 29 Mar. 2019 (Attorney Docket No. ZEN19-1002PSP), the contents of which are incorporated herein by reference.

### BACKGROUND

### Field

The disclosed embodiments generally relate to the design of customer-support systems for ecommerce systems. More specifically, the disclosed embodiments relate to a system that facilitates segmenting users and associated events to provide actionable insights in an ecommerce system.

### Related Art

As electronic commerce continues to proliferate, customers are beginning to use online customer-support resources to solve problems, and to obtain information related to various products or services. These online customer-support resources commonly include customer-support ticketing systems, which are designed to help customers resolve their problems, either by providing information to the customers, or by facilitating online interactions with customer-support agents. When designed properly, these online customer-support systems can automate customer-service interactions, thereby significantly reducing a company's customer-service costs.

Customer-support systems are beginning to make use of event-driven architectures. Event-driven architectures are comprised of highly decoupled event-processing modules, which asynchronously generate, receive and process event notifications. The benefit of an event-driven architecture is that it enables large numbers of event producers and event consumers to efficiently exchange information in near real-time without having dependencies of the need to be aware of one another.

Event-driven architectures can provide significant advantages in customer-support systems because they facilitate tracking activities associated with system users. For example, events can be used to tell a story about actions of a user who is interacting with an ecommerce system. This makes it possible to: upsell to the user; mitigate arising problems for the user; attract more or fewer of a specific kind of user; and influence certain types of user activity. Moreover, by storing events associated with users, it is possible to perform “segmentation operations” involving the events. For example, we may want to identify a specific subset of users that have done A but not B within time interval t. Unfortunately, existing customer-support systems with event-driven architectures presently provide little support for performing such segmentation operations; they only provide limited mechanisms for identifying users based on their actions.

Hence, what is needed is an event-based customer-support system that facilitates segmenting users and associated events in an ecommerce system to provide actionable insights.

### SUMMARY

The disclosed embodiments relate to a system that segments users and/or associated events for an ecommerce system to facilitate actionable insights. During operation, the system receives a query to segment users of the ecommerce system and/or events associated with user actions, wherein the query comprises a Boolean expression with a list of filters that are applied attributes of the users and/or events to form filter groups, and wherein the filter groups are joined by logical operators. Next, the system performs a search based on the query to produce a result set comprising a list of users and/or events that satisfy the query. Finally, the system displays the result set to a customer-support agent for the ecommerce system to facilitate actionable insights or trigger some sort of workflow.

In some embodiments, to support dynamic segmentation, a filter group can be a time-based filter group, which has a time-based entry condition and/or a time-based expiration condition. In these embodiments, the system automatically updates membership in time-based filter groups at periodic intervals based on the time-based entry and/or expiration conditions.

In some embodiments, an event can be a future event or a past event. In these embodiments, upon receiving a request to modify an event, the system determines whether the event has already occurred, and then allows the modification to proceed only if the event has not yet occurred, or if the event has occurred and a grace period for modifications has not yet expired.

In some embodiments, an event can include one of the following: a user sign-up event; a user-password-reset event; a user-login-event; an add-payment-method event; an add-to-cart event; an add-subscription event; a check-out event; a rating-of-product/service event; and an open-support-ticket event.

In some embodiments, the logical operators include AND, OR and NOT.

In some embodiments, filters can based on an event attribute, which can include: an event type; an occurrence of an event; a non-occurrence of an event; an event property; an event source; an event count, which specifies a number of times an event occurred; a time window for an event; a sum or aggregation of event properties across a set of events; and a support-ticket associated with an event and/or a user.

In some embodiments, filters can be based on a user attribute from a user profile, which can include: a user name; a user location; and a user age.

In some embodiments, a filter can be based on an aggregation of values for an event property across multiple events of the same type, such as a price being summed across the multiple events.

In some embodiments, receiving the query involves receiving the query from the customer-support agent for the ecommerce system through a user interface.

In some embodiments, performing the search based on the query involves using a database system to facilitate the search.

### BRIEF DESCRIPTION OF THE FIGURES

FIG. 1 illustrates a computing environment including an application and an associated ticketing system in accordance with the disclosed embodiments.

FIG. 2 illustrates components in a ticketing system in accordance with the disclosed embodiments.

FIG. 3 illustrates an exemplary event-driven computing system in accordance with the disclosed embodiments.

FIG. 4 presents a flow chart illustrating operations performed while segmenting users and/or events in accordance with the disclosed embodiments.

FIG. 5 presents a flow chart illustrating operations performed to support dynamic segmentation in accordance with the disclosed embodiments.

FIG. 6 presents a flow chart illustrating operations performed to support future events in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Segmentation

To gain actionable insights, our system enables a customer-service agent to segment users and/or associate events based on criteria specified by filter groups. By doing so, we can make each filter group specific and mutually exclusive to one another and we can thereby compute each filter group independently without strict ordering. Each filter group is defined by a self-contained Boolean expression, and the segmentation involves a list of filter groups joined by logical operators, such as ANDs and ORs. Each filter group performs a specific type of filtering, which can be based on: a user attribute, an event type, or an event property (which performs a search across different event types).

For example, a segmentation can look like the following:

=[(Users who live in San Francisco) OR (Users who live in Oakland)] AND (Users who have not logged in in the last 90 days) AND (Users whose subscription_status equals PAID).
Once a segment has been defined, our system allows customers to apply various actions to members of the segment through an API.

Segmentation can be static or dynamic. Static segmentation is based on a snapshot of a group of users who satisfy a set of qualifying criteria given a particular point in time. In contrast, dynamic segmentation is based on a continuous evaluation of a group of users based on the set of criteria. For example, consider the segment “users who are age 30.” For this segment, you expect users to age-in and age-out of the segment as time progresses.

Segments can be specified in a number of ways. Some segments are specified based on user attributes in a user profile. For example, a segment can be specified as, profile_attribute (first_name exists, city equals San Francisco).

Segments can also be specified based on segment type with associated segment filters that can be based on: an event occurrence or non-occurrence; an event property filter; an event source; and an event count. This makes it possible to perform corresponding queries, such as: (1) show me users who have done a check-out within the last 7 days for which a coupon code exists; show me users who have opened more than 7 support tickets within the last two days; or show me users who have not done a login within the last 30 days.

Segments can also be specified based on event properties. This creates an opportunity for an event store to index events based on segments instead of users. For example, we can instrument a view_movie event and supplement it with a genre and a movie_id. This enables us to display the movies a person viewed in reverse-chronological order. By creating an event-property-based index, we can see events from a movie_id perspective, to determine which users viewed the movie; we can also do the same with genre. This is a powerful feature because it facilitates defining generic expressions inside of an events property payload without the need to store this multiple times (on the user object, on the movie object, etc. . . . ). Moreover, by creating this type of index, we provide the ability to search events across users. We can also say, given this movie_id, show me all the people that have interacted with it.

Before describing segmentation further, we first describe a computing environment and associated customer-support system in which the segmentation process operates.

### Computing Environment

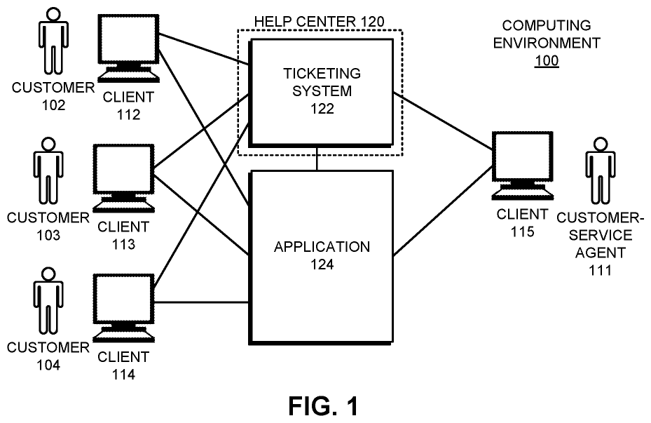

FIG. 1 illustrates an exemplary computing environment 100 in which an event-driven computing system operates. Computing environment 100 includes an application 124 and ticketing system 122. Within computing environment 100, a number of customers 102-104 interact with application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a help center 120 to obtain help dealing with issues, which can include various problems and questions. For example, a user of accounting software may need help using a feature of the accounting software, or a customer of a website that sells sporting equipment may need help cancelling an order that was erroneously entered. This help may be provided by a customer-service agent 111 who operates a client computer system 115 and interacts with customers 102-104 through help center 120. This help may also comprise automatically suggested helpful articles that the customer can read to hopefully resolve the problem or question. Note that customer-service agent 111 can access application 124 (either directly or indirectly through help center 120) to help resolve an issue.

In some embodiments, help center 120 is not associated with computer-based application 124, but is instead associated with another type of product or service that is offered to a customer. For example, help center 120 can provide assistance with a product, such as a television, or with a service such as a package-delivery service.

Help center 120 organizes customer issues using a ticketing system 122, which generates tickets to represent each customer issue. Ticketing systems are typically associated with a physical or virtual “help center” (or “help desk”) for resolving customer problems. Note that, although the present invention is described with reference to a ticketing system, it is not meant to be limited to customer-service interactions involving ticketing systems. In general, the invention can be applied to any type of system that enables a customer to resolve a problem with a product or service provided by an organization.

Ticketing system 122 comprises a set of software resources that enable a customer to resolve an issue. In the illustrated embodiment, specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier, and information (or links to information) associated with the problem. For example, this information can include: (1) information about the problem; (2) customer information for one or more customers who are affected by the problem; (3) agent information for one or more customer-service agents who are interacting with the customer; (4) email and other electronic communications about the problem (which, for example, can include a question posed by a customer about the problem); (5) information about telephone calls associated with the problem; (6) timeline information associated with customer-service interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-service agent.

Ticketing system 122 is described in further detail below.

### Ticketing System

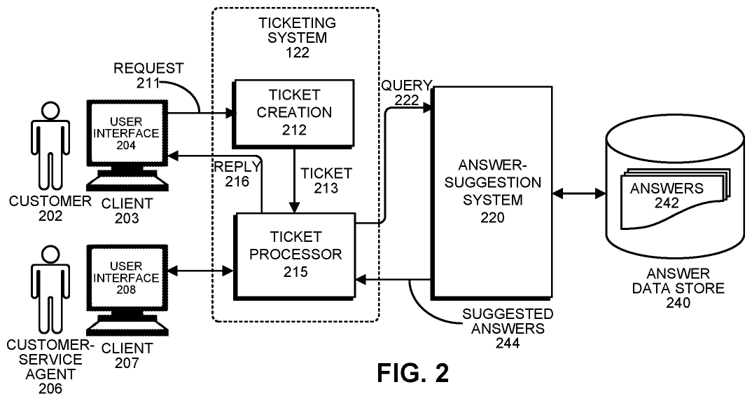

FIG. 2 illustrates a number of processes, which are associated with a ticketing system 122 and an associated answer-suggestion system 220, in accordance with the disclosed embodiments. One of the processes starts with a ticket-creation operation 212 that takes place within ticketing system 122. This ticket-creation operation 212 is triggered by actions of a customer 202 operating on a client 203 through a user interface 204 who has an issue with a product or a service, and submits a request 211 to obtain help with the issue. Note that customer 202 can submit request 211 through a number of possible channels, including through email, online forms, social networking sites, etc. In response to request 211, the ticket-creation operation 212 produces a ticket 213 that feeds into a ticket processor 215.

Next, ticket processor 215 can send a query 222, which is associated with the customer request 211 and the corresponding ticket 213, to an answer-suggestion system 220. Then, answer-suggestion system 220 obtains a set of suggested answers 244 from a set of answers 242 contained in an answer data store 240. Next, answer-suggestion system 220 returns the suggested answers 244 to ticket processor 215, which sends a reply 216 containing the suggested answers 244 to a user interface 204 to be displayed to customer 202. Note that user interface 204 can be implemented in a number of different ways for both mobile and desktop platforms. For example, user interface 204 can be incorporated into: a web page, an email, or a UI screen provided by an application.

User interface 208 enables customer-support agent 206 to perform a customer-support operation in response to the customer requests. For example, the customer-support operation can include: suggesting an agent's answer or a helpful article to a customer; creating, editing or deleting an answer or article; or configuring a chatbot to facilitate resolving the customer request.

Many of the operations performed by ticketing system 122 are controlled by an event-driven architecture, which is described in more detail below.

### Event-Driven Computing System

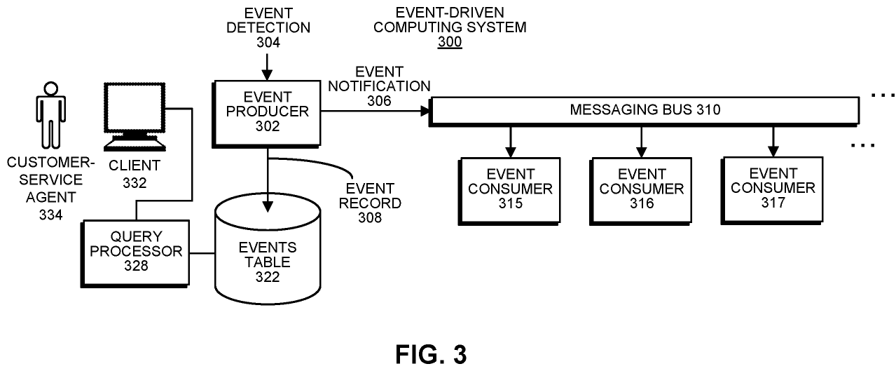

FIG. 3 illustrates an exemplary event-driven computing system 300 in accordance with the disclosed embodiments. As mentioned above, an event-driven computing system includes both event producers, such as event producer 302, and event consumers 315-317. Event producers are entities, such as applications or software modules, which detect an event, and signal that the event has occurred. Event consumers 315-317 are entities that need to know the event has occurred; they may be involved in processing the event or they may simply be affected by the event. Event consumers 315-317 typically operate by monitoring a “messaging bus” or “streaming platform,” such as Apache Kafka™, which carries event notifications generated by event producers. In general, the term “messaging bus” can refer to any type of streaming platform or bus that can carry event notifications, and is not limited to a specific streaming platform, such as Apache Kafka™.

As illustrated in FIG. 3, event-driven computing system 300 includes an event producer 302, which is a programming component that detects an event 304. (In general, the detected event can include any type of hardware-related or software-related occurrence, which can affect the execution of any component or system associated with event producer 302 and event consumers 315-317.) In response to the event detection 304, event producer 302 writes an event record 308, to an events table 322. Event producer 302 also writes a corresponding event notification 306 to a messaging bus 310. The published event notification subsequently propagates through messaging bus 310, which enables it to be received by event consumers 315-317.

Event-driven computing system 300 also supports query operations involving events. As illustrated in FIG. 3, a query processor 328 can perform various queries on events located in events table 322, for example to facilitate segmentation operations associated with the events. Results of these query operations can be presented to a customer-service agent 334 through a client 332.

### Segmentation Process

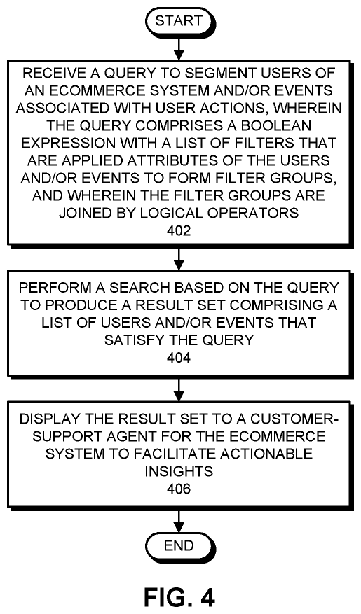

FIG. 4 presents a flow chart illustrating operations performed while segmenting users and/or events in accordance with the disclosed embodiments. During operation, the system receives a query to segment users of an ecommerce system and/or events associated with user actions, wherein the query comprises a Boolean expression with a list of filters that are applied attributes of the users and/or events to form filter groups, and wherein the filter groups are joined by logical operators (step 402). Next, the system performs a search based on the query to produce a result set comprising a list of users and/or events that satisfy the query (step 404). Finally, the system displays the result set to a customer-support agent for the ecommerce system to facilitate actionable insights (step 406).

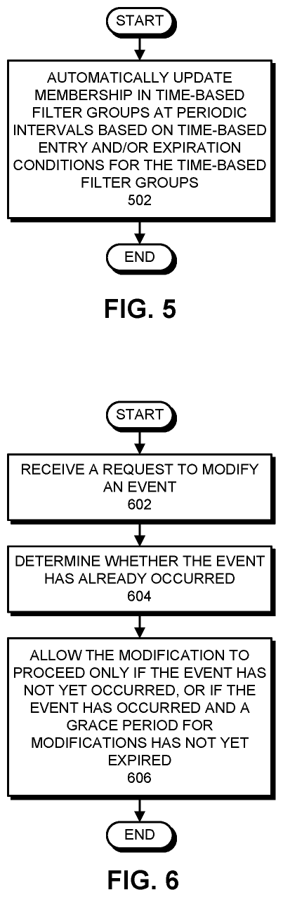

FIG. 5 presents a flow chart illustrating operations performed to support dynamic segmentation in accordance with the disclosed embodiments. In this case, a filter group can be a time-based filter group, which has a time-based entry condition and/or a time-based expiration condition. To support dynamic segmentation, the system automatically updates membership in time-based filter groups at periodic intervals based on the time-based entry and/or expiration conditions for the time-based filter groups (step 502).

FIG. 6 presents a flow chart illustrating operations performed to support future events in accordance with the disclosed embodiments. When the system receives a request to modify an event (step 602), the system determines whether the event has already occurred (step 604). The system then allows the modification to proceed only if the event has not yet occurred, or if the event has occurred and a grace period for modifications has not yet expired (step 606).

### Segmentation Use Cases

The ability to perform segmentation operations can facilitate a number of use cases in an ecommerce system. In particular, the results of segmentation operations can be used by a recommendation service and a conversation service in the customer-support system.

A recommendation service has two objectives. The first objective is to help to identify a group of users (customers) to target based on a desired goal. The second objective is to provide personalization for interactions with customers on an individual or group basis. If your goal is to increase the number of logins for an ecommerce site, there are a large number of possible ways to segment your audience. For, segmentation can facilitate answering the following questions.
Is the forgot password reset mechanism working? (Perhaps your customers forgot their passwords and cannot log back in.)
Are customers having a hard time navigating the site to find items of interest?
Is the market catering to a cyclical or seasonal crowd (i.e., snowboarding)?
   A segmentation system can be used to answer these questions, and this can facilitate automatically taking action to reach the target group of users.

A conversation service provides a way to group customers and common topics. These conversations can either be initiated by the customer with a particular request, or a conversation can be proactively created to try to alleviate a potential problem. Within a customer-support system, businesses often use a “user profile service” to model their customers, so it will be very natural to also add conversation data into such user profiles. One way to do that is to store all conversation data into the profile attributes. For example, a conversation object can contain: (1) an ID, (2) a start timestamp, (3) an end timestamp, (4) a number of messages, and (5) participants. Note that these messages can be modeled as events, wherein each event is of the type “conversation” with its corresponding “source” and “properties,” and the event properties contain the information about the sender and the actual message itself.

To retrieve all information for a conversation, one could make the following query to the event service:
GET
/v2/events?identifier=“mycompanyX:customeremail:foo@bar.com”&type=conversation&start_ts=150394123&end_ts=150394456
   Internally, a chat “belongs” to a customer, and a customer can have multiple chats, which means that a conversation “belongs” to a customer profile, and a customer profile can contains multiple conversations.

Segmentation provides more flexibility when it comes to designing and implementing conversations using event and profile services. Events can be stored against the user profiles from which they are sent, and each entry in the conversation can be represented as an event with the property “conversation id: <conv_id>.” For example, we can use segmentation to retrieve all entries for a conversation as follows.
segmentation/events?type=conversation&subject_id=<subject_id>
   This allows us to run support more segmentation use cases on profiles, for example to search for all profiles that has at least one conversation, etc.

Hence, a conversation service can be greatly extended by utilizing a segmentation/recommendation engine. For example, a conversation can facilitate the following use cases.

(1) Latest conversation view—Because each customer profile contains all information about the relevant conversations, we can build an interface that displays all the conversations for a customer with the latest messages. We can also display the entire interaction history, which consists of many distinct conversations between the customer and the business, instead of all messages being thrown into one single timeline.

(2) Segmentation based on past or ongoing conversations—Because all messages are stored as events, it is possible to activate segmentation to gain more insight and visibility customer bases. For example, if segmentation can detect that a customer is unhappy and is about to churn, the business would be notified, so that a customer-support agent could react by trying to engage with the customers again or to send the customer a retention promotional code.

(3) Recommendation based on past or ongoing conversations—Because all messages are being stored as events, it is possible to activate a recommendation engine to mine for data/patterns in the stored messages. There are many applications for this type of integration. In one use case, a business can set up triggers to perform actions when the recommendation engine gains some insight into its customers based on all messages and data in the system. For example, if a customer inquires about specific lines of products, the recommendation engine can suggest a list of relevant SKUs for the business to show on such customer's landing page to help drive sales conversions.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for segmenting users and associated events for an ecommerce system to facilitate actionable insights, the method comprising:
receiving a query to segment users of the ecommerce system and/or events associated with user actions, wherein the query comprises a Boolean expression with a list of filters that are applied attributes of the users and/or events to form filter groups, and wherein the filter groups are joined by logical operators;
performing a search based on the query to produce a result set comprising a list of users and/or events that satisfy the query; and
displaying the result set to a customer-support agent for the ecommerce system to facilitate actionable insights.

2. The method of claim 1,
wherein to support dynamic segmentation, a filter group can be a time-based filter group, which has a time-based entry condition and/or a time-based expiration condition; and
wherein the method automatically updates membership in time-based filter groups at periodic intervals based on the time-based entry and/or expiration conditions.

3. The method of claim 1,
wherein to support future events, an event can be a future event or a past event; and
wherein upon receiving a request to modify an event, the method further comprises:
determining whether the event has already occurred, and
allowing the modification to proceed only if the event has not yet occurred, or if the event has occurred and a grace period for modifications has not yet expired.

4. The method of claim 1, wherein an event can include one of the following:
a user sign-up event;
a user-password-reset event;
a user-login-event;
an add-payment-method event;
an add-to-cart event;
an add-subscription event;
a check-out event;
a rating-of-product-or-service event; and
an open-support-ticket event.

5. The method of claim 1, wherein the logical operators include AND, OR and NOT.

6. The method of claim 1, wherein at least one of the filters is based on an event attribute, which can include:
an event type;
an occurrence of an event;
a non-occurrence of an event;
an event property;
an event source;
an event count, which specifies a number of times an event occurred;
a time window for an event;
a sum or aggregation of event properties across a set of events; and
a support-ticket associated with an event and/or a user.

7. The method of claim 1, wherein at least one of the filters is based on a user attribute from a user profile, which can include:
a user name;
a user location; and
a user age.

8. The method of claim 1, wherein a filter can be based on an aggregation of values for an event property across multiple events of the same type.

9. The method of claim 1, wherein receiving the query involves receiving the query from the customer-support agent for the ecommerce system through a user interface.

10. The method of claim 1, wherein performing the search based on the query involves using a database system to facilitate the search.

11. The method of claim 1, wherein the method is performed by a recommendation service, wherein the result set is a target group of customers selected based on a desired goal, and wherein in addition to displaying the result set, the method automatically contacts the target group of customers to further the desired goal.

12. The method of claim 1, wherein the method is performed by a conversation service, wherein events can have a conversation type, and wherein the results set includes events for messages associated with one or more conversations to facilitate viewing the one or more conversations.

13. A non-transitory computer-readable storage medium storing instructions that when executed by a computer cause the computer to perform a method for segmenting users and associated events for an ecommerce system to facilitate actionable insights, the method comprising:
receiving a query to segment users of the ecommerce system and/or events associated with user actions, wherein the query comprises a Boolean expression with a list of filters that are applied attributes of the users and/or events to form filter groups, and wherein the filter groups are joined by logical operators;
performing a search based on the query to produce a result set comprising a list of users and/or events that satisfy the query; and
displaying the result set to a customer-support agent for the ecommerce system to facilitate actionable insights.

14. The non-transitory computer-readable storage medium of claim 13,
wherein to support dynamic segmentation, a filter group can be a time-based filter group, which has a time-based entry condition and/or a time-based expiration condition; and
wherein the method automatically updates membership in time-based filter groups at periodic intervals based on the time-based entry and/or expiration conditions.

15. The non-transitory computer-readable storage medium of claim 13,
wherein to support future events, an event can be a future event or a past event; and
wherein upon receiving a request to modify an event, the method further comprises:
determining whether the event has already occurred, and
allowing the modification to proceed only if the event has not yet occurred, or if the event has occurred and a grace period for modifications has not yet expired.

16. The non-transitory computer-readable storage medium of claim 13, wherein an event can include one of the following:
a user sign-up event;
a user-password-reset event;
a user-login-event;
an add-payment-method event;
an add-to-cart event;
an add-subscription event;
a check-out event;
a rating-of-product/service event; and
an open-support-ticket event.

17. The non-transitory computer-readable storage medium of claim 13, wherein the logical operators include AND, OR and NOT.

18. The non-transitory computer-readable storage medium of claim 13, wherein at least one of the filters is based on an event attribute, which can include:
an event type;
an occurrence of an event;
a non-occurrence of an event;
an event property;
an event source;
an event count, which specifies a number of times an event occurred;
a time window for an event;
a sum or aggregation of event properties across a set of events; and
a support-ticket associated with an event and/or a user.

19. The non-transitory computer-readable storage medium of claim 13, wherein at least one of the filters is based on a user attribute from a user profile, which can include:
a user name;
a user location; and
a user age.

20. The non-transitory computer-readable storage medium of claim 13, wherein a filter can be based on an aggregation of values for an event property across multiple events of the same type.

21. The non-transitory computer-readable storage medium of claim 13, wherein receiving the query involves receiving the query from the customer-support agent for the ecommerce system through a user interface.

22. The non-transitory computer-readable storage medium of claim 13, wherein performing the search based on the query involves using a database system to facilitate the search.

23. The non-transitory computer-readable storage medium of claim 13, wherein the method is performed by a recommendation service, wherein the result set is a target group of customers selected based on a desired goal, and wherein in addition to displaying the result set, the method automatically contacts the target group of customers to further the desired goal.

24. The non-transitory computer-readable storage medium of claim 13, wherein the method is performed by a conversation service, wherein events can have a conversation type, and wherein the results set includes events for messages associated with one or more conversations to facilitate viewing the one or more conversations.

25. A system that segments users and associated events for an ecommerce system to facilitate actionable insights, comprising:
at least one processor and at least one associated memory; and
a segmentation mechanism, which executes on the at least one processor, wherein during operation, the segmentation mechanism:
receives a query to segment users of the ecommerce system and/or events associated with user actions, wherein the query comprises a Boolean expression with a list of filters that are applied attributes of the users and/or events to form filter groups, and wherein the filter groups are joined by logical operators;
performs a search based on the query to produce a result set comprising a list of users and/or events that satisfy the query; and
displays the result set to a customer-support agent for the ecommerce system to facilitate actionable insights.

26. The system of claim 25,
wherein to support dynamic segmentation, a filter group can be a time-based filter group, which has a time-based entry condition and/or a time-based expiration condition; and
wherein the segmentation mechanism automatically updates membership in time-based filter groups at periodic intervals based on the time-based entry and/or expiration conditions.

27. The system of claim 25,
wherein to support future events, an event can be a future event or a past event; and
wherein upon receiving a request to modify an event, the system:
determines whether the event has already occurred, and
allows the modification to proceed only if the event has not yet occurred, or if the event has occurred and a grace period for modifications has not yet expired.

28. The system of claim 25, wherein a filter can be based on an aggregation of values for an event property across multiple events.

29. The system of claim 25, wherein receiving the query involves receiving the query from the customer-support agent for the ecommerce system through a user interface.

30. The system of claim 25, wherein performing the search based on the query involves using a database system to facilitate the search.
